(19) United States
(12) Patent Application Publication
(10) Pub. No.: US 2026/0156295 A1
(43) Pub. Date: Jun. 4, 2026

(54) METHOD AND APPARATUS FOR ENCODING MUNTI VIEW VIDEO SEQUENCE AND MEOTHD FOR TRANSMITTING DATA GENERATED BY MUNTI VIEW VIDEO SEQUENCE ENCODING MEHTOD

(71) Applicant: RESEARCH & BUSINESS FOUNDATION SUNGKYUNKWAN UNIVERSITY, Suwon-si (KR)

(72) Inventors: Eun-Seok RYU, Seoul (KR); Jae Yeol CHOI, Seoul (KR); Jong Beom JEONG, Seoul (KR); Jun Hyeong PARK, Seoul (KR); Young Gyu KIM, Seoul (KR)

(73) Assignee: RESEARCH & BUSINESS FOUNDATION SUNGKYUNKWAN UNIVERSITY, Suwon-si (KR)

(21) Appl. No.: 19/408,604

(22) Filed: Dec. 4, 2025

(30) Foreign Application Priority Data
Dec. 4, 2024 (KR) 10-2024-0178154

(51) Int. Cl. H04N 19/597; H04N 19/503

(52) U.S. Cl. CPC H04N 19/597; H04N 19/503

(57) ABSTRACT

A method and apparatus for encoding a multi view video sequence, and a method for transmitting data generated by the multi view video sequence encoding method are provided. The method of encoding the multi view video sequence may comprise obtaining 4-dimensional neural voxels and standard Gaussians for the multi view video sequence from the multi view video sequence, generating a bitstream by encoding the 4-dimensional neural voxels, and pruning the standard Gaussians.

### CROSS REFERENCE TO RELATED APPLICATION

The present application claims priority to Korean Patent Application No. 10-2024-0178154 filed Dec. 4, 2025, the entire contents of which is incorporated herein for all purposes by this reference.

### BACKGROUND OF THE INVENTION

### Field of the Invention

The present disclosure relates to a method and apparatus for encoding a multi view video sequence, and a method for transmitting data generated by the multi view video sequence encoding method, and relates to a method for more efficiently encoding and decoding a multi view video sequence through encoding of four-dimensional neural voxels and standard Gaussian pruning.

### Description of the Related Art

With the recent advancements in virtual reality equipment and immersive media content, the need for techniques capable of expressing three-dimensional spatial images with a sense of depth is growing.

3-dimensional image representation techniques that support six degrees of freedom (6DoF) rendering are divided into view synthesis-based techniques and spatial reconstruction techniques. View synthesis-based approaches perform fragmentation based on common parts of a multi view immersive video to reduce the size of the video, and then reconstruct and synthesize them at a decoding time to provide an image corresponding to a new viewpoint. A representative example is the MPEG immersive video (MIV) standard. On the other hand, spatial reconstruction-based techniques enable the inference of visual characteristics of coordinates in a 3-dimensional space through implicit or explicit modeling. In addition to traditional point cloud-based methods, there are neural radiance fields (NeRF) and 3D Gaussian splatting (3DGS) methods that train 3D models using multi view images as input.

### SUMMARY

An object of the present disclosure is to provide a method of efficiently encoding a multi view video sequence, thereby reducing data transmission during real-time streaming of diverse content.

In addition, an object of the present disclosure is to provide a method capable of addressing a file size problem of a dynamic data representation version of 3DGS, which is a high-quality 3D visual scene representation model, and minimizing rendering quality loss.

In addition, an object of the present disclosure is to provide a method of transmitting data generated by a multi view video sequence encoding method.

In addition, an object of the present disclosure is to provide a recording medium storing data generated by a multi view video sequence encoding method.

In addition, an object of the present disclosure is to provide a recording medium storing data received and decoded by a multi view video sequence decoding apparatus and used for reconstruction of a multi view video sequence.

The technical problems solved by the present invention are not limited to the above technical problems and other technical problems which are not described herein can be clearly understood by a person having ordinary skill in the technical field to which the present invention belongs from the description below.

A method of encoding a multi view video sequence according to an aspect of the present disclosure may comprise obtaining 4-dimensional neural voxels and standard Gaussians for the multi view video sequence from the multi view video sequence, generating a bitstream by encoding the 4-dimensional neural voxels, and pruning the standard Gaussians.

An apparatus for encoding a multi view video sequence according to an aspect of the present disclosure may comprise a memory and at least one processor. The at least one processor may obtain 4-dimensional neural voxels and standard Gaussians for the multi view video sequence from the multi view video sequence, generate a bitstream by encoding the 4-dimensional neural voxels and prune the standard Gaussians.

The features briefly summarized above regarding the present disclosure are merely exemplary aspects of the detailed description of the present disclosure that follows and do not limit the scope of the present disclosure.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic diagram illustrating a compression system of a 3DGS model according to an embodiment of the present disclosure;

FIG. 2 is a flowchart illustrating a multi view video sequence encoding method according to an embodiment of the present disclosure;

FIG. 3 is a flowchart illustrating a 4D neural voxel encoding method according to an embodiment of the present disclosure;

FIG. 4 is a flowchart illustrating a 4D neural voxel decoding method according to an embodiment of the present disclosure;

FIGS. 5 and 6 are flowcharts illustrating a Gaussian pruning method according to an embodiment of the present disclosure; and

FIGS. 7 and 8 are diagrams illustrating experimental result data according to embodiments of the present disclosure.

### DESCRIPTION OF THE PREFERRED EMBODIMENTS

Hereinafter, with reference to the accompanying drawings, embodiments of the present disclosure will be described in detail so that those skilled in the art can easily practice them. However, the present disclosure may be implemented in many different forms and is not limited to the embodiments described herein.

In describing embodiments of the present disclosure, if it is determined that detailed descriptions of known configurations or functions may obscure the subject matter of the present disclosure, detailed descriptions thereof will be omitted. In addition, in the drawings, parts that are not related to the description of the present disclosure are omitted, and similar parts are given similar reference numerals.

In the present disclosure, when it is said that a component is “connected,” “coupled,” or “linked” to another component, this may include not only a direct connection relationship, but also an indirect connection relationship in which another component exists in between. In addition, when it is said that a component “include” or “have” another component, this does not mean excluding the other component, but may further include another component, unless specifically stated to the contrary.

In the present disclosure, terms such as first and second are used only for the purpose of distinguishing one component from other components, and do not limit the order or important score of the components unless specifically mentioned. Accordingly, within the scope of the present disclosure, a first component in one embodiment may be referred to as a second component in another embodiment, and similarly, a second component in one embodiment may be referred to as a first component in another embodiment.

In the present disclosure, distinct components are intended to clearly explain each feature, and do not necessarily mean that the components are separated. That is, a plurality of components may be integrated to form one hardware or software unit, or one component may be distributed to form a plurality of hardware or software units. Accordingly, even if not specifically mentioned, such integrated or distributed embodiments are also included in the scope of the present disclosure.

In the present disclosure, components described in various embodiments do not necessarily mean essential components, and some may be optional components. Accordingly, embodiments consisting of a subset of the components described in one embodiment are also included in the scope of the present disclosure. In addition, embodiments that include other components in addition to the components described in the various embodiments are also included in the scope of the present disclosure.

In the present disclosure, “/” and “,” may be interpreted as “and/or”. For example, “A/B” and “A, B” may be interpreted as “A and/or B”. Additionally, “A/B/C” and “A, B, C” may mean “at least one of A, B, and/or C.”

In the present disclosure, “or” may be interpreted as “and/or.” For example, “A or B” may mean 1) “A” only, 2) “B” only, or 3) “A and B.” Alternatively, “or” in the present disclosure may mean “additionally or alternatively.”

### Problems of Related Art

NeRF-based neural network-based 3D reconstruction models have the advantage of being able to learn 3D visual information as low-capacity artificial neural networks. However, NeRF-based neural network-based 3D reconstruction models have long convergence times due to the nature of learning weights of neural networks. In addition, in order to sample a plurality of points on a ray during image rendering, since there is always a need for inference on the neural network, rendering times are also long, making real-time processing for virtual and augmented reality impossible.

In contrast, 3DGS-based 3D reconstruction models have a high potential for practical use in virtual reality devices, as multiple Gaussian distributions in a 3D space configure a scene, which can be projected into a 2D image and then quickly rendered using a conventional rasterizer. However, 3DGS-based 3D reconstruction models increase file size because the scene is explicitly reconstructed, which poses a significant obstacle to the development of transmission systems.

To address this, various methods for compressing 3DGS have emerged. Representative examples include a method of storing an index by representing the most frequent attribute values of individual 3D Gaussians in a codebook, a method of removing unnecessary Gaussians through masking, and a method of using artificial neural networks instead of spherical harmonic coefficients occupying large capacity.

However, these methods are only methods of compressing 3DGS models that express static space, and no clear compression technology for dynamic 3DGS models that can express immersive video content has emerged.

### Object and Summary of the Present Disclosure

To address these problems, the present disclosure proposes methods for resolving the file size problem of the dynamic data representation version of 3DGS, a high-quality 3D visual scene representation model, and minimizing rendering quality loss.

The methods proposed through the present disclosure are summarized below.

First, the present disclosure partitions a 4-dimensional neural voxel tensor, which embeds visual elements in a 4-dimensional space including a temporal axis, into lower dimensions, and then encodes it by applying inter or intraframe prediction.

Next, the present disclosure minimizes quality loss by removing unnecessary 3D Gaussian distributions in a standard Gaussian network, which is a component of a 4DGS model (hereinafter referred to as ‘Gaussians’, ‘Gaussian’, ‘standard Gaussians’ or ‘standard Gaussians’), based on contribution scores.

### Compression System of 3DGS Model (Multi View Video Sequence System)

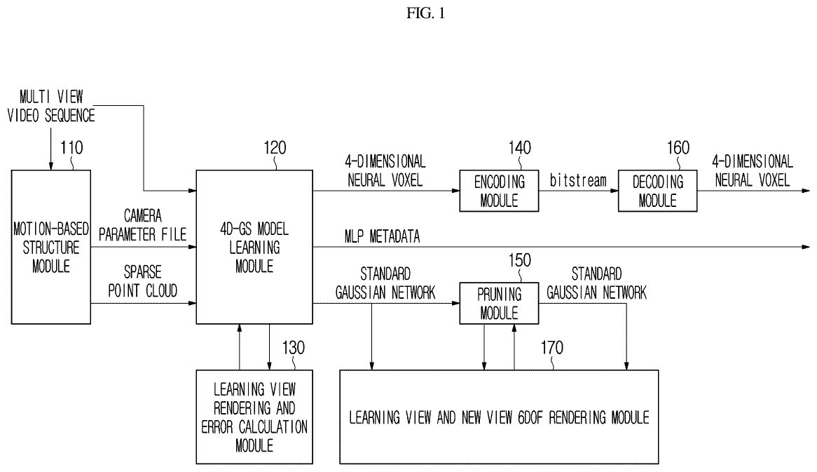

FIG. 1 is a diagram illustrating a multi view video sequence system.

Referring to FIG. 1, the multi view video sequence system may be configured to include a motion-based structure module 110, a 4D-GS model learning module 120, a learning view rendering and error calculation module 130, an encoding module 140, a pruning module 150, a decoding module 160, and a learning view and new view 6DoF rendering module 170.

A multi view video sequence system may include a multi view video sequence encoding apparatus and a multi view video sequence decoding apparatus. The multi view video sequence encoding apparatus may be referred to as a “server” or “server level”, and the multi view video sequence decoding apparatus may be referred to as a “client” or “client level”. The multi view video sequence encoding apparatus may include a motion-based structure module 110, a 4D-GS model learning module 120, a learning view rendering and error calculation module 130, an encoding module 140, and a pruning module 150, and the multi view video sequence decoding apparatus may include a decoding module. The learning view and new view 6DoF rendering module 170 may be included in the multi view video sequence encoding apparatus or may be located outside the multi view video sequence encoding apparatus.

A multi view video sequence may be a collection of videos of the same scene, shot from different locations and orientations. A multi view video sequence is temporally synchronized, meaning that the same timestamp in each video represents the scene at the same point in time.

The motion-based structure module 110 extracts similar features from multi view images to acquire camera parameters, and may use them to calculate positional information of each camera. Furthermore, the motion-based structure module 110 may backproject the extracted features into a three-dimensional structure to generate a sparse point cloud set. Software such as Colmap, developed using motion-based structure algorithms, may be optionally used in the motion-based structure module 110.

The camera parameter file and sparse point cloud generated as a result of the multi view video sequence and the motion-based structure module 110 may be input to the 4D-GS model learning module 120. The 4D-GS model learning module 120 may be any 3D spatial learning module that stores embeddings for position and time information as neural voxels and includes Gaussians. In this case, learning may be performed by calculating the error between the ground truth image included in the multi view video sequence and the image rendered through a 3DGS renderer and applying the gradient descent method based on the error. This learning process may be performed in the learning view rendering and error calculation module 130.

New viewpoints may be rendered using the training results, which occupy large capacity. Therefore, the 4D neural voxels and standard Gaussians, which account for approximately 92.5% of the training results, may be compressed. The multi-layer perceptron (MLP) and metadata, which account for approximately 7.5%, may be preserved.

The 4D neural voxels may be compressed into a bitstream through the encoding module 140, which is a quantization and video codec-based compression module. Standard Gaussians, another component, may be compressed through the pruning module 150.

The data required to play compressed data as a 3D video at the client level (multi view video sequence decoding apparatus) may be a bitstream, pruned standard Gaussians, and MLP metadata. The decoding module 160 may reconstruct 4D neural voxels from the bitstream. The learning view and new view 6DoF rendering module 170 may render a video corresponding to a viewpoint with 6 degrees of freedom from the standpoint of a virtual reality device wearer by receiving a reconstruction model as input. The learning view and new view 6DoF rendering module 170 is different from the existing Gaussian renderer in that it queries 3DGS for a value calculated by adding a difference value derived from a 4D neural voxel and renders it.

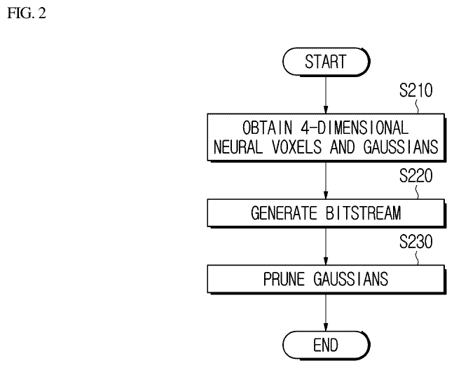

FIG. 2 is a flowchart illustrating a multi view video sequence encoding method according to an embodiment of the present disclosure.

Referring to FIG. 2, 4-dimensional neural voxels and standard Gaussians for a multi view video sequence may be obtained from the multi view video sequence (S210). The standard Gaussians may be referred to as a “standard Gaussian network,” “Gaussian,” or “Gaussian distribution.”

A bitstream may be generated by encoding the 4D neural voxels (S220). The 4D neural voxels may be encoded based on partitioning into 2D planes, inter or intra prediction, quantization, etc.

Standard Gaussians may be pruned to generate pruned standard Gaussians (S230). The pruning process may be performed based on at least one of a threshold value, opacity, and important score.

### 4D Neural Voxel Encoding and Decoding

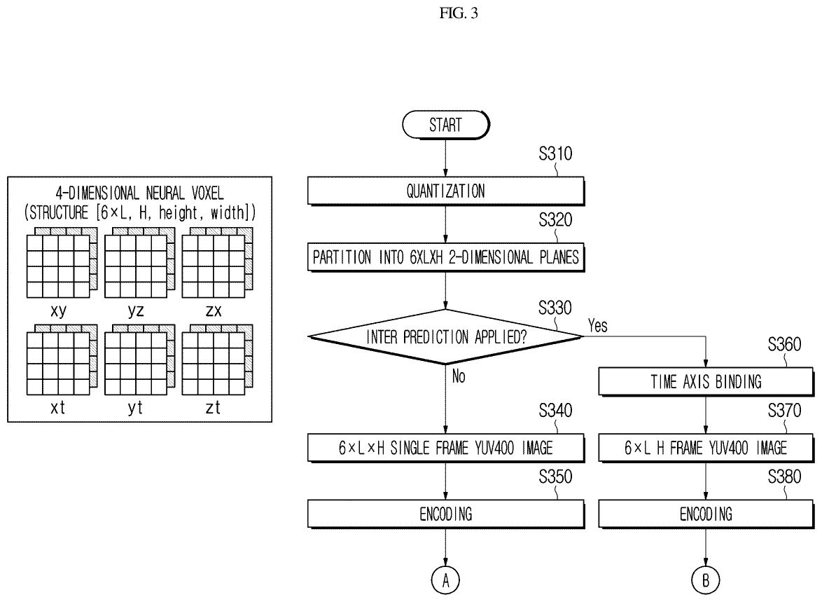

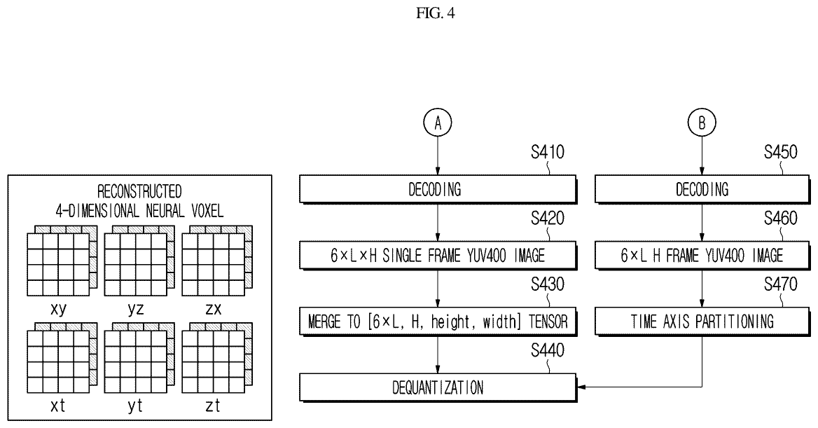

FIG. 3 is a flowchart illustrating a method of encoding a 4-dimensional neural voxel according to an embodiment of the present disclosure, and FIG. 4 is a flowchart illustrating a method of decoding a 4-dimensional neural voxel according to an embodiment of the present disclosure.

FIG. 3, which is a flowchart at the server level (a multi view video sequence encoding apparatus), may be composed of 4-dimensional neural voxels containing a learned feature embedding, a quantization module (S310), plane partitioning (S320), temporal axis merging (binding) (S360), a YUV format image (S340, S370), and encoding (S350, S380). The flowchart at the client level (a multi view video sequence decoding apparatus) may be composed of decoding (S410, S450), tensor format storage (S420, S460), tensor merging (S430, S470), temporal axis partitioning (S470), and dequantization (S440), through which reconstructed 4-dimensional neural voxels may be generated. A compressed video bitstream may be transmitted between the server and the client.

Referring to FIG. 3, the 4-dimensional neural voxels given as input is in the form of a 4-dimensional tensor and may have a structure of [6×L, H₁, H₂, H₃]. Here, 6 is calculated because the number of combinations that may be created by combining two each of the location and time elements x, y, z, and t is 6, and L is a parameter indicating the number of resolutions. Hereinafter, H₁, H₂, and H₃, which constitute the dimensions, may be defined as parameters, and in the present disclosure, H₂ and H₃ are defined as the height and width, respectively, and H₁ is defined as the number of feature embedding channels of the corresponding plane.

The learned 4-dimensional neural voxel may mean an embedding for a visual element in which two are combined. This has a 32-bit decimal data type, and in the present disclosure, 8-bit or 16-bit quantization may be applied to the 4-dimensional neural voxels for application of a video codec (S310). When an original value is x and the target number of bits is n, quantization may be performed using the equation of

$$\frac{{2}^{n} - 1}{M - m} \times ( x - m ) .$$

M and m represent the maximum and minimum values within the existing 32-bit tensor.

A 4 dimensional tensor may be partitioned into 6×L×H 2-dimensional planes (S320). The partitioning process may be implemented in parallel using the numpy library.

Thereafter, two methods may be performed depending on whether the inter prediction mode is selected (S330). If the inter prediction mode is used, temporal axis binding (S360) may be applied. Temporal axis binding may be a process of combining feature planes (partitioned 4-dimensional neural voxels) by setting the H₁ axis as the temporal axis. When the distribution of feature values is visualized and the H₁ axis is diversified, features existing at similar H₂ and H₃ coordinates exhibit similar values, so inter prediction may be useful in such cases.

Python lists may be packed in YUV format (S340, S370). In this case, 4D neural voxels, partitioned into planes, may be converted into YUV400 format, which has only the value of the Y component. YUV400 image may represent a single-frame image when inter prediction is not applied (No in S330), and may represent a video when inter prediction is applied (Yes in S330).

Thereafter, a bitstream may be generated by encoding the 4D neural voxels (partitioned 4D neural voxels or 4D neural voxels with combined feature planes) (S350, S380). Video codecs such as HEVC, VVC, and AV1 may be selectively applied to the encoding according to a compatible apparatus on the decoder side. The compressed bitstream may be transmitted to the client along with other 4D-GS training results.

Referring to FIG. 4, the client side may decode the bitstream (S410, S450) and reconstruct the YUV400 format (S420, S460). Thereafter, the Python 4-dimensional tensor form may be reconstructed through the reverse process (S430, S470, S440) of the process performed on the server side. Among them, the dequantization process (S440) may be performed through the formula

$$\frac{M - m}{{2}^{n} - 1} \times x + m .$$

The meaning of n, M, m, and x are as described in FIG. 3. The finally reconstructed 4-dimensional neural voxel may be used in the 4D-GS 6-DOF new view synthesis process.

### Standard Gaussian Pruning

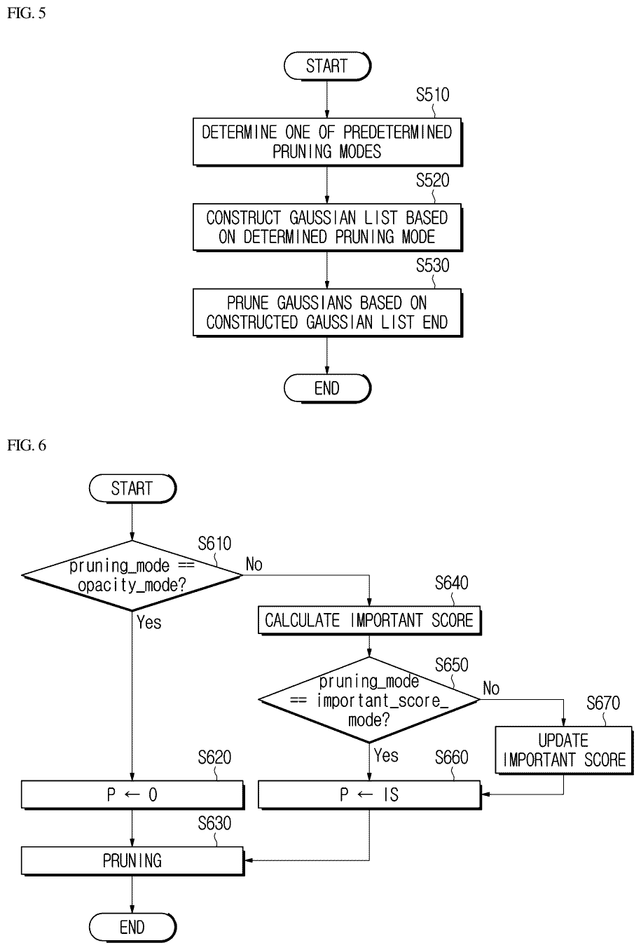

FIG. 5 is a flowchart illustrating a standard Gaussian pruning method according to an embodiment of the present disclosure.

Referring to FIG. 5, one of predetermined pruning modes may be determined (S510). The predetermined pruning modes may include an opacity mode (opacity_mode), an important score mode (important_score_mode), and a volume important score mode (volume_important_score_mode).

A Gaussian list may be constructed based on the determined pruning mode (S520). The Gaussian list may include one or more standard Gaussians. The standard Gaussians may be pruned based on the constructed Gaussian list (S530). Pruning may be performed based on a predetermined threshold value.

FIG. 6 is a flowchart illustrating a method of selectively applying standard Gaussian pruning according to a pruning mode.

To perform the pruning process, a trained Gaussian network

$${( G )}_{i}^{N} ,$$

a multi view video sequence

$${( T )}_{k}^{M} ,$$

and camera parameter information

$${( M )}_{k}^{M}$$

are required. In FIG. 6, the important score list used in the pruning algorithm is represented as IS, the opacity information list is represented as O, and the final pruning target Gaussian list is represented as P. The pruning ratio p is a user-specified parameter, by adjusting which the resulting file size may be selectively adjusted.

Referring to FIG. 6, it may be determined whether the pruning mode pruning_mode is an opacity mode (S610).

If the pruning mode is either the important score mode or the volume important score mode (i.e., the pruning mode is not the opacity mode), an important score may be calculated based on the frequency of rendering in the learning view (S640). The process of calculating the important score may be performed according to Table 1 below.

```
TABLE 1
IS ← initialize(IS, 0)
for each T, M in (T)ₖ^{M} , (M)ₖ^{M} do
  for each x in T do
    IntersectedIndex ← FindIntersectedfromDeformed((G)ᵢ^{N} , M, x)
        for each i in IntersectedIndex do
          IS[i] ← IS[i] + Gᵢ, opacity
      end for
  end for
end for
```

After identifying overlapping Gaussians for rays originating from all learning views, if it is hit, the opacity value of the Gaussian may be accumulated to the important score value of the Gaussian to construct an important score list.

If the pruning mode is a volume important score mode (S650), the important score value may be updated once more (S670). This may be done by applying a weight according to the volume of the Gaussian. After sorting the Gaussian list by volume, normalization may be performed on all Gaussians based on the volume of the Gaussian with a preset k-th index. Through this process, a volume important score list, which is a Gaussian list for the volume important score mode, may be constructed (S660). The important score update may be performed according to Table 2 below.

TABLE 2

SortedVol ← Sort(CalculatedVolume((G)ᵢ^{N}))
V_k ← SortedVol[k]
V_{normalize} ← min(max((G)ᵢ^{N}), volume), 0), 1)
IS ← IS × V_{normalize}

If the pruning mode is an opacity mode, the pruning list is composed of a list of opacity values (S620), and if the pruning mode is an important score mode or volume important score mode, the pruning list may be composed of a final updated important score list (S660).

To explain the process of pruning standard Gaussians using a pruning list, first, a value which corresponds to an index corresponding to a pruning ratio percentage among the total number of Gaussians may be set as a threshold value. Then, all Gaussians are traversed, and values smaller than the threshold value are masked to construct the final pruned Gaussian list (S630).

The pruning process may be performed as shown in Table 3 below.

TABLE 3

```
i ← floor(p*len(P))
threshold ← sort(P)[i]
for i ← to len(P) do
  if P[i] < threshold then
    mask[i] ← 0
  else
    mask[i] ← 1
  end for
prunedGaussians ← G & mask
```

The present disclosure is different from the existing LightGaussian algorithm in that the Gaussian pruning operation is performed on the standard Gaussian corresponding to the transformed coordinate system rather than on the Gaussian corresponding to the 3D coordinates given as input. This is because a process of mapping the 3D coordinates of all time periods to the 3D coordinates of a single time period through an artificial neural network is included due to the characteristics of the standard Gaussian network.

### Experimental Result Data

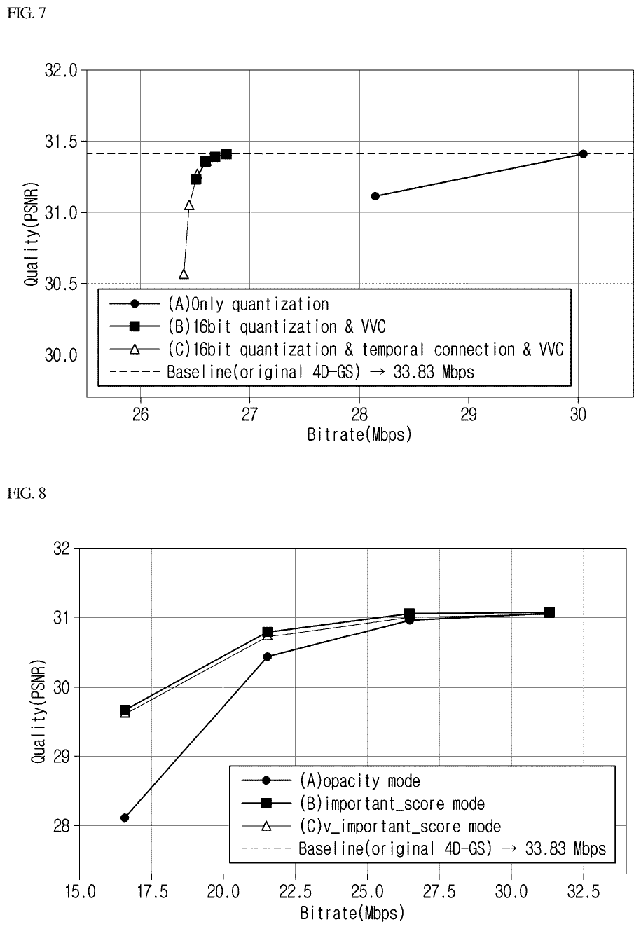

FIGS. 7 and 8 are views showing experimental result data according to embodiments of the present disclosure.

First, FIG. 7 shows the experimental results of the 4D neural voxel encoding and decoding method proposed through the present disclosure. Referring to FIG. 7, compared to the basic 4D-GS model (Baseline) without compression, it can be seen that when only 16 quantizations are performed, the bit rate is reduced by approximately 3 Mbps without any performance degradation. Meanwhile, when performing encoding using the VVC codec and then performing decoding and rendering, it can be seen that the overall model size may be reduced by approximately 7 Mbps.

Next, FIG. 8 shows the experimental results demonstrating the effectiveness of the standard Gaussian pruning proposed through the present disclosure. Referring to FIG. 8, it can be seen that data size is reduced by more than 5 Mbps through a PSNR loss of less than 0.5 dB.

Table 4 shows the experimental results comparing the performance when simultaneously performing the proposed 4D neural voxel compression technique and Gaussian pruning technique with other 3D video representation techniques.

TABLE 4

| | PSNR(dB) | SSIM | LPIPS | Bitrate(Mbps) |
|---|---|---|---|---|
| K-Planes | 31.39 | 0.9405 | 0.2117 | 129.36 |
| TeTriRF | 28.71 | 0.8673 | 0.3209 | 5.15 |
| 4D-GS | 31.41 | 0.9364 | 0.1492 | 33.83 |
| Ours (Low) | 30.77 | 0.9293 | 0.1602 | 13.42 |
| Ours (High) | 31.10 | 0.9345 | 0.1516 | 19.43 |

The proposed techniques were tested by defining a high-compression mode (Low) and a low-compression mode (High). As shown in Table 4, in both cases, the bitrate was reduced to 13 to 20 Mbps while maintaining rendering quality at around 31 dB. This may be interpreted as the techniques proposed through the present disclosure having advantages in both quality and bitrate.

In the embodiments described above, the methods are described based on a flowchart as a series of steps or units; however, the present disclosure is not limited to the order of the steps, and some steps may occur in a different order or simultaneously with other steps described above.

Additionally, those skilled in the art will appreciate that the steps depicted in the flowchart are not exclusive, and that other steps may be included or one or more steps of the flowchart may be deleted without affecting the scope of the present disclosure.

The above-described embodiments include examples of various aspects. While it is not possible to describe all possible combinations to illustrate the various aspects, those skilled in the art will recognize that other combinations are possible. Accordingly, the present disclosure is intended to encompass all other alterations, modifications, and variations within the scope of the following claims.

The embodiments of the present disclosure described above may be implemented in the form of program instructions that can be executed by various computer components and recorded on a computer-readable recording medium. The computer-readable recording medium may include program instructions, data files, data structures, etc., alone or in combination. The program instructions recorded on the computer-readable recording medium may be those specially designed and configured for the present disclosure or may be known and available to those skilled in the art of computer software. Examples of the computer-readable recording medium include magnetic media such as hard disks, floppy disks, and magnetic tapes, optical recording media such as CD-ROMs and DVDs, magneto-optical media such as floptical disks, and hardware devices specially configured to store and execute program instructions such as ROMs, RAMS, and flash memories. Examples of program instructions include not only machine language codes generated by a compiler, but also high-level language codes that may be executed by a computer using an interpreter, etc. The hardware devices may be configured to operate as one or more software modules to perform processing according to the present disclosure, and vice versa.

In the embodiments described above, the methods are described based on a flowchart as a series of steps or units. However, the present disclosure is not limited to the order of the steps, and some steps may occur in a different order or simultaneously with other steps described above. Furthermore, those skilled in the art will appreciate that the steps depicted in the flowchart are not exclusive, and that other steps may be included, or one or more steps of the flowchart may be deleted without affecting the scope of the present disclosure.

The above-described embodiments include examples of various aspects. While it is not possible to describe all possible combinations to illustrate the various aspects, those skilled in the art will recognize that other combinations are possible. Accordingly, the present disclosure is intended to encompass all other alterations, modifications, and variations within the scope of the following claims.

The embodiments of the present disclosure described above may be implemented in the form of program instructions that can be executed by various computer components and recorded on a computer-readable recording medium. The computer-readable recording medium may include program instructions, data files, data structures, etc., alone or in combination. The program instructions recorded on the computer-readable recording medium may be those specially designed and configured for the present disclosure or may be known and available to those skilled in the art of computer software. Examples of the computer-readable recording medium include magnetic media such as hard disks, floppy disks, and magnetic tapes, optical recording media such as CD-ROMs and DVDs, magneto-optical media such as floptical disks, and hardware devices specially configured to store and execute program instructions such as ROMs, RAMS, and flash memories. Examples of program instructions include not only machine language codes generated by a compiler, but also high-level language codes that may be executed by a computer using an interpreter, etc. The hardware devices may be configured to operate as one or more software modules to perform processing according to the present disclosure, and vice versa.

Although the present disclosure has been described above with specific details such as specific components and limited examples and drawings, these are provided only to help a more general understanding of the present disclosure, and the present disclosure is not limited to the above examples, and a person having ordinary knowledge in the technical field to which the present disclosure belongs may make various modifications and variations from this description.

Therefore, the spirit of the present disclosure should not be limited to the embodiments described above, and all modifications that are equal or equivalent to the following claims as well as the claims are considered to fall within the scope of the spirit of the present disclosure.

According to the present disclosure, adaptive 3D video compression becomes possible, thereby enabling the development of a feature embedding compression technique compatible with video compression standards, and enabling the development of a dynamic 3D Gaussian compression technique compatible with a 3D Gaussian renderer.

Furthermore, according to the present disclosure, it is possible to provide the effect of reducing a bitrate of a multi view video sequence compared to conventional techniques.

Furthermore, according to the present disclosure, since the features of 4D neural voxels partitioned into two dimensions are temporally connected, the number of decoders required at the client level during the encoding process can be reduced.

The effects that can be obtained from the present disclosure are not limited to the effects mentioned above, and other effects that are not mentioned will be clearly understood by a person having ordinary skill in the art to which the present disclosure pertains from the description below.

What is claimed is:

1. A method of encoding a multi view video sequence, the method comprising:
obtaining 4-dimensional neural voxels and standard Gaussians for the multi view video sequence from the multi view video sequence;
generating a bitstream by encoding the 4-dimensional neural voxels; and
pruning the standard Gaussians.

2. The method of claim 1, wherein the generating the bitstream comprises:
partitioning the 4-dimensional neural voxels into two-dimensional planes; and
determining whether inter prediction is applied to the partitioned 4-dimensional neural voxels.

3. The method of claim 2, wherein the generating the bitstream comprises:
upon determining that the inter prediction is applied, combining one or more feature planes of the partitioned 4-dimensional neural voxels based on a time axis of the partitioned 4-dimensional neural voxels; and
generating the bitstream based on the 4-dimensional neural voxels in which the feature planes are combined.

4. The method of claim 2, wherein the generating the bitstream comprises:
upon determining that the inter prediction is not applied, generating the bitstream based on the partitioned 4-dimensional neural voxels.

5. The method of claim 1, wherein the pruning the standard Gaussians comprises:
constructing a Gaussian list including one or more of the standard Gaussians based on one of predetermined pruning modes; and
pruning the standard Gaussians in the Gaussian list based on a predetermined threshold value.

6. The method of claim 5, wherein when the pruning mode of the standard Gaussians is an opacity mode among the predetermined pruning modes, the Gaussian list is composed of the opacity of the standard Gaussians.

7. The method of claim 5, wherein the constructing the Gaussian list comprises:
calculating important scores of the standard Gaussians based on a rendering frequency of the standard Gaussians when the pruning mode of the standard Gaussians is an important score mode or a volume important score mode among the predetermined pruning modes; and
constructing an important score list by accumulating the opacity of the standard Gaussians to important scores of the standard Gaussians.

8. The method of claim 7, wherein the constructing the Gaussian list further comprises constructing a volume important score list by applying weights to the standard Gaussians in the important score list based on volumes of the standard Gaussians, when the pruning mode of the standard Gaussians is the volume important score mode.

9. An apparatus for encoding a multi view video sequence, the apparatus comprising:
a memory; and
at least one processor,
wherein the at least one processor is configured to:
obtain 4-dimensional neural voxels and standard Gaussians for the multi view video sequence from the multi view video sequence;
generate a bitstream by encoding the 4-dimensional neural voxels; and
prune the standard Gaussians.

10. A method for transmitting data generated by a multi view video sequence encoding method, the multi view video sequence encoding method comprising:
obtaining 4-dimensional neural voxels and standard Gaussians for the multi view video sequence from the multi view video sequence;
encoding the 4-dimensional neural voxels to generate a bitstream; and
pruning the standard Gaussians.
